(19) United States
(12) Patent Application Publication
(10) Pub. No.: US 2024/0127462 A1
(43) Pub. Date: Apr. 18, 2024

(54) MOTION GENERATION SYSTEMS AND METHODS

(71) Applicants: NAVER CORPORATION, Gyeonggi-do (KR); NAVER LABS CORPORATION, Seongnam-si (KR)

(72) Inventors: Thomas LUCAS, Grenoble (FR); Fabien BARADEL, Grenoble (FR); Philippe WEINZAEPFEL, Montbonnot-Saint-Martin (FR); Gregory ROGEZ, Gières (FR)

(73) Assignees: NAVER CORPORATION, Gyeonggi-do (KR); NAVER LABS CORPORATION, Seongnam-si (KR)

(21) Appl. No.: 17/956,022

(22) Filed: Sep. 29, 2022

(51) Int. Cl. G06T 7/262; G06T 7/285; G06V 10/28; G06V 10/82

(52) U.S. Cl. CPC G06T 7/262; G06T 7/285; G06V 10/28; G06V 10/82

(57) ABSTRACT

A motion generation system includes: a model configured to generate latent indices for a sequence of images including an entity performing an action based on an action label and a duration of the sequence; and a decoder module configured to: decode the latent indices and to generate the sequence of images including the entity performing the action based on the latent indices; and output the sequence of images including the entity performing the action to a display control module configured to display the sequence of images including the entity performing the action sequentially on a display.

### FIELD

The present disclosure relates to image processing systems and methods and more particularly to systems and methods for generating sequences of predicted three dimensional (3D) human motion.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Images (digital images) from cameras are used in many different ways. For example, objects can be identified in images, and a navigating vehicle can travel while avoiding the objects. Images can be matched with other images, for example, to identify a human captured within an image. There are many more other possible uses for images taken using cameras.

A mobile device may include one or more cameras. For example, a mobile device may include a camera with a field of view covering an area where a user would be present when viewing a display (e.g., a touchscreen display) of the mobile device. This camera may be referred to as a front facing (or front) camera. The front facing camera may be used to capture images in the same direction as the display is displaying information. A mobile device may also include a camera with a field of view facing the opposite direction as the camera referenced above. This camera may be referred to as a rear facing (or rear) camera. Some mobile devices include multiple front facing cameras and/or multiple rear facing cameras.

### SUMMARY

In a feature, a motion generation system includes: a model configured to generate latent indices for a sequence of images including an entity performing an action based on an action label and a duration of the sequence; and a decoder module configured to: decode the latent indices and to generate the sequence of images including the entity performing the action based on the latent indices; and output the sequence of images including the entity performing the action to a display control module configured to display the sequence of images including the entity performing the action sequentially on a display.

In further features, the motion generation system further includes: an encoder module configured to encode an input sequence of images including an entity into latent representations; and a quantizer module configured to quantize the latent representations, where the model is configured to generate the latent indices further based on the quantized latent representations.

In further features, the encoder module includes an auto-regressive encoder.

In further features, the encoder module includes the Transformer architecture.

In further features, the encoder module includes a deep neural network.

In further features, the encoder module is configured to encode the input sequence of images including the entity into the latent representations using causal attention.

In further features, the encoder module is configured to encode the input sequence of images into the latent representations using masked attention maps.

In further features, the quantizer module is configured to quantize the latent representations using a codebook.

In further features, the action label and the duration is set based on user input.

In further features, the decoder module includes an auto-regressive encoder.

In further features, the decoder module includes a deep neural network.

In further features, the deep neural network includes the Transformer architecture.

In further features, the model includes a parametric differential body model.

In further features, the entity is one of a human, an animal, and a mobile device.

In a feature, a training system includes: the motion generation system; and a training module configured to: input a training sequence of images including the entity into the encoder module; receive an output sequence generated by the decoder module based on the training sequence; and selectively train at least one of the encoder module, the quantizer module, and the decoder module based on matching the output sequence with the training sequence.

In further features, the training module is configured to train the model after the training of the encoder module, the quantizer module, and the decoder module.

In further features, the training module is configured to train the model based on adjusting an output of the model toward an expected output of the model stored in memory given an input.

In a feature, a motion generation method includes: by a model, generating latent indices for a sequence of images including an entity performing an action based on an action label and a duration of the sequence; decoding the latent indices and to generate the sequence of images including the entity performing the action based on the latent indices; and outputting the sequence of images including the entity performing the action to a display control module configured to display the sequence of images including the entity performing the action sequentially on a display.

In further features, the motion generation method further includes: encoding an input sequence of images including an entity into latent representations using an encoder module; and quantizing the latent representations, where generating the latent indices comprises generating the latent indices further based on the quantized latent representations.

In further features, the encoder module includes an auto-regressive encoder.

In further features, the encoder module includes the Transformer architecture.

In further features, the encoder module includes a deep neural network.

In further features, the encoding includes encoding the input sequence of images including the entity into the latent representations using causal attention.

In further features, the encoding includes encoding the input sequence of images into the latent representations using masked attention maps.

In further features, the quantizing includes quantizing the latent representations using a codebook.

In further features, the motion generation method further includes setting the action label and the duration based on user input.

In further features, the decoding includes decoding using an auto-regressive encoder.

In further features, the decoder module includes a deep neural network.

In further features, the deep neural network includes the Transformer architecture.

In further features, the model includes a parametric differential body model.

In further features, the entity is one of a human, an animal, and a mobile device.

In further features, the motion generation method further includes: input a training sequence of images including the entity to the encoder module, where the decoding is by a decoder module and the quantizing is by a quantizer module; receiving an output sequence generated by the decoder module based on the training sequence; and selectively training at least one of the encoder module, the quantizer module, and the decoder module based on matching the output sequence with the training sequence.

In further features, the training method further includes training the model after the training of the encoder module, the quantizer module, and the decoder module.

In further features, the training the model includes training the model based on adjusting an output of the model toward an expected output of the model stored in memory given an input.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example computing device;

FIG. 2 includes, on the left, an example input sequence of observations and, on the right, an example input sequence of observations and additionally a sequence of three dimensional (3D) renderings of a human performing an action;

FIG. 3 includes a functional block diagram of an example implementation of a rendering module;

FIGS. 4-7 include example block diagrams of a training system;

FIG. 8 includes an example illustration of causal attention;

FIG. 9 includes example sequences of humans performing a selected action for selected durations generated without input observations;

FIG. 10 includes two rows of human motion sequences generated by the rendering module;

FIG. 11 includes one input pose input and human motion sequences generated by the rendering module for the actions of turning, touching face, walking, and sitting; and

FIG. 12 is a flowchart depicting an example method of training the rendering module.

In the drawings, reference numbers may be reused to identify similar and/or identical elements.

### DETAILED DESCRIPTION

Generating realistic and controllable motion sequences is a complex problem. The present application involves systems and methods for generating motion sequences based on zero, one, or more than one observation including an entity. The entities described in embodiments herein are human. Those skilled in the art will appreciate that the described systems and methods may extend to entities that are animals (e.g., a dog) or mobile devices (e.g., a multi-legged robot). An auto-regressive transformer based encoder may be used to compress human motion in the observation(s) into quantized latent sequences. A model includes an encoder module that maps human motion into latent representations (latent index sequences) in a discrete space, and a decoder module that decodes latent index sequences into predicted sequences of human motion. The model may be trained for next index prediction in the discrete space. This allows the model to output distributions on possible futures, with or without conditioning on past motion. The discrete and compressed nature of the latent space allows the model to focus on long-range signals as the model removes low level redundancy in the input. Predicting discrete indices also alleviates the problem of predicting averaged poses which may cause a failure when regressing continuous values as the average of a discrete targets is not a target itself. The systems and methods described herein provide better results than other systems and methods.

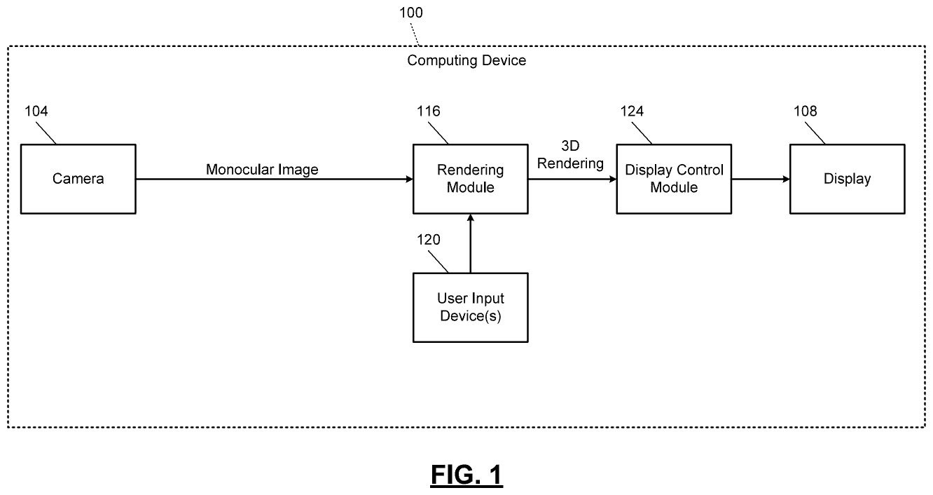

FIG. 1 is a functional block diagram of an example implementation of a computing device 100. The computing device 100 may be, for example, a smartphone, a tablet device, a laptop computer, a desktop computer, or another suitable type of computing device.

A camera 104 is configured to capture images. For some types of computing devices, the camera 104, a display 108, or both may not be included in the computing device 100. The camera 104 may be a front facing camera or a rear facing camera. While only one camera is shown, the computing device 100 may include multiple cameras, such as at least one rear facing camera and at least one forward facing camera. The camera 104 may capture images at a predetermined rate (e.g., corresponding to 60 Hertz (Hz), 120 Hz, etc.), for example, to produce video. The rendering module 116 is discussed further below.

A rendering module 116 generates a sequence of three dimensional (3D) renderings of a human as discussed further below. The length of the sequence (the number of discrete renderings of a human) and the action performed by the human in the sequence are set based user input from one or more user input devices 120. Examples of user input devices include but are not limited to keyboards, mouses, track balls, joysticks, and touchscreen displays. In various implementations, the length of the sequence and the action may be stored in memory.

A display control module 124 (e.g., including a display driver) displays the sequence of 3D renderings on the display 108 one at a time or concurrently. The display control module 124 may update what is displayed at the predetermined rate to display video on the display 108. In various implementations, the display 108 may be a touchscreen display or a non-touch screen display.

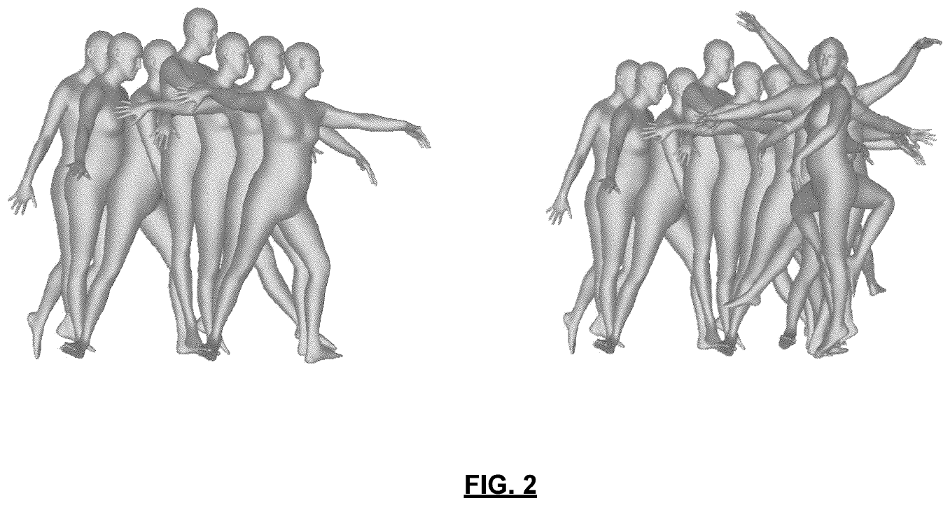

As an example, the left of FIG. 2 includes an example input sequence of observations, such as extracted from images or retrieved from memory. The right of FIG. 2 includes the input sequence of observations and additionally includes a sequence of three dimensional (3D) renderings of a human performing an action. As discussed above, no input sequence of observations is needed.

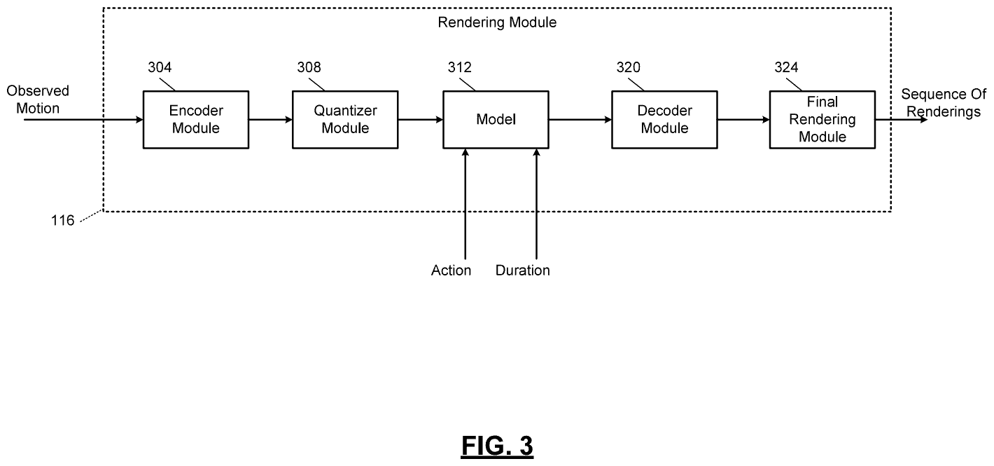

FIG. 3 includes a functional block diagram of an example implementation of the rendering module 116 includes an encoder module (E) 304 that includes the transformer architecture. Transformer architecture as used herein is described in Ashish Vaswani, Noam Shazeer, Niki Parmar, Jakob Uszkoreit, Llion Jones, Aidan N Gomez, Łukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present application is also applicable to the use of other types of attention mechanisms. The encoder module 304 encodes input human motion (observed motion) to produce encodings (e.g., one or more vectors or matrices). In other words, the encoder module 304 maps an input human motion sequence p to latent representations \hat{Z}, respectively. For example, one latent representation (e.g., vector) may be generated for each instantaneous image/pose of the input sequence (latent index sequences).

A quantizer module 308 (q(·)) quantizes the encodings (latent representations) into a discrete latent space. The quantizer module 308 outputs, for example, centroid numbers (i¹, i², . . . , i^{t}). The encoder module 304 and the quantizer module 308 are used if observed motion is input. The quantizer module 308 quantizes the encodings using a codebook (Z), such as a lookup table or an equation.

A model (G) 312 generates a human motion sequence based on an action label and a duration and, if observed motion is input, the output of the quantizer module 308. The action label indicates an action to be illustrated by the human motion sequence. The duration corresponds to or includes the number of human poses in the human motion sequence. The model 312 sequentially predicts latent indices (i^{t+1}, i^{t+2}, . . . , i^{T}) based on the action label, the duration, and optionally the output of the quantizer module 308. A latent index may be one which is inferred from empirical data because it is not determined directly.

A decoder module 320 (D) decodes the latent indices output by the model 312 into a human motion sequence including humans posed at the number of instances of the duration and the human motion sequence illustrating performance of the action. The decoder module 320 reconstructs the human motion \hat{p} from the quantized latent space z_{q}.

The model 312 may be an auto regressive generative model. By factorizing distributions over time, auto-regressive generative models can be conditioned on past sequences of arbitrary length. As discussed above, human motion is compressed into a space that is lower dimensional and discrete to reduce input redundancy in the example of use of the observed motion. This allows for training of the model 312 using discrete targets rather than regressing in continuous space such that the average of targets is not a valid output itself. The causal structure of the time dimension is kept in the latent representations such that it respects the passing of time (e.g., only the past influences the present). This involves the causal attention in the encoder module 304. This enables training of the model 312 based on observed past motions of arbitrary length. The model 312 captures human motion directly in the learned discrete space. The decoder module 320 may generate parametric 3D models which represent human motion as a sequence of human 3D meshes, which are continuous and high dimensional representation. The proposed discretization of human motion alleviates the need for the model to capture low level signals and enables the model 312 to focus on long range relations. While the space of human body model parameters may be high dimensional and sparse, the quantization concentrates useful regions into a finite set of points. Random sequences in that space produce locally realistic sequences that lack temporal coherence. The training used herein is to predict a distribution of the next index in the discrete space. This allows for probabilistic modelling of possible futures, with or without conditioning on the past.

A final rendering module 324 may add color and/or texture to the sequence, such as to make the humans in the sequence more lifelike. The final rendering module 324 may also perform one or more other rendering functions. In various implementations, final rendering module 324 may be omitted.

Human actions defined by body motions can be characterized by the rotations of body parts, disentangled from the body shape. This allows the generation of motions with actors of different morphology. The model 312 may include a parametric differential body model which disentangles body parts rotations from the body shape. Examples of parametric differential body models include the SMPL body model and the SMPL-X body model. The SMPL body model is described in Loper M, et al., SMPL: A Skinned Multi-Person Linear Model, in TOG, 2015, which is incorporated herein in its entirety. The SMPL-X body model is described in Pavlakos, G., et.al., Expressive Body Capture: 3D Hands, Face, and Body from a Single Image, In CVPR, 2019, which is incorporated herein in its entirety.

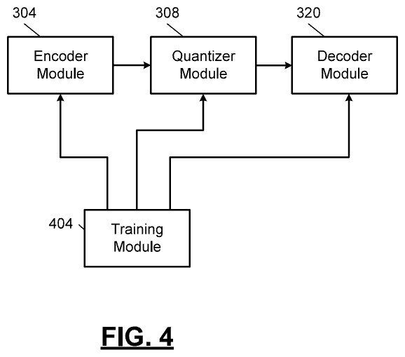

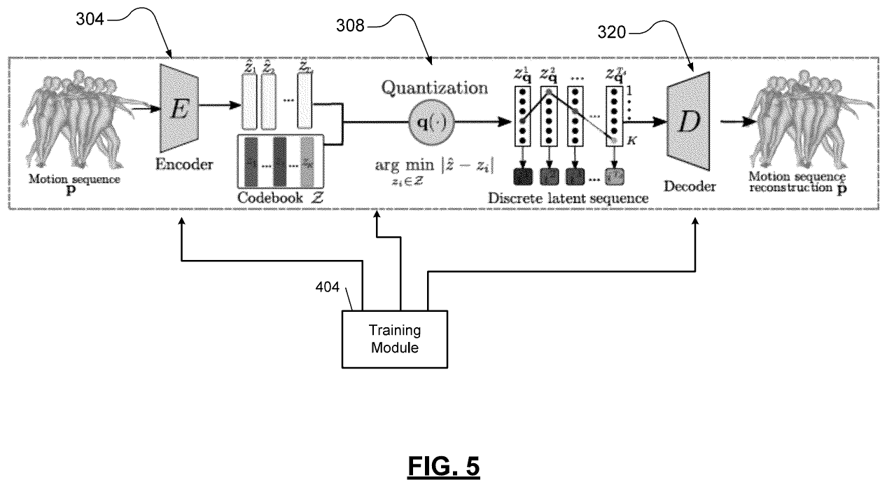

A human motion p of length T can be represented as a sequence of body poses and translations of the root joints: p={(θ₁, δ₁), . . . , (θ_{T}, δ_{T})} where θ and δ represent the body pose and the translation, respectively. The encoder module 304 E and the quantizer module 308 q encode and quantize pose sequences. The decoder module 320 reconstructs \hat{p}=D(q(E(p)). Causal attention mechanisms of the encoder module 304 maintain a temporally coherent latent space and neural discrete representation learning for quantization. Training of the encoder module 304, the quantizer module 308, and the decoder module 320 is discussed in conjunction with the examples of FIGS. 4 and 5.

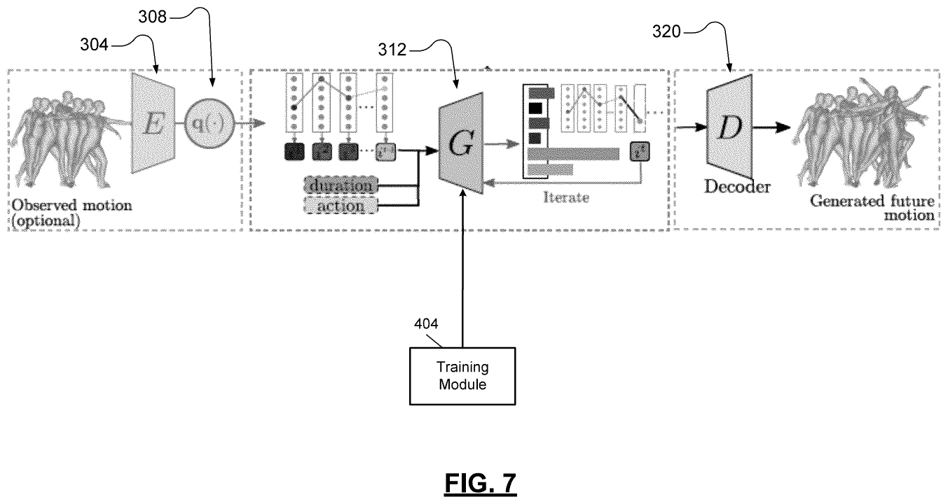

The encoder module 304 represents human motion sequences as a latent sequence representation \hat{z}={\hat{z}¹, . . . ,\hat{z}^{T}^{_{d}}}=E(p) where T_{d}≤T is the temporal dimension of the latent sequence. The latent representations may be arranged in order of time such that for any t ≤T_{d}{\hat{z}₁, . . . ,\hat{z}ₜ} depends (e.g., only) on {p₁, . . . ,p_{[t·T/T}_{_{D]}}} such as illustrated in FIG. 7. Transformer (attention mechanisms) with causal attention of the encoder module 304 may perform this. This avoids inductive priors besides causality by modeling interactions between all inputs using self attention modified with respect to the passing (direction) of time. Intermediate representation may be mapped by the encoder module 304 using three feature-wise linear projections into query Q ϵ [symbol] ^{Nxd}^{ₖ}, key K ϵ [symbol] ^{Nxd}^{ₖ}, and value V ϵ [symbol] ^{Nx} ^{ₖ}. A causal mask performed by the encoder module 304 may be defined by the equation C_{i,j}=−∞· [symbol] i>j [symbol] + [symbol] i≤j [symbol] where the output of the encoder module 304 is determined using the equation:

$$Attn ( Q , K , V ) = softmax ( \frac{Q {K}^{t} \cdot C}{\sqrt{{d}_{k}}} ) V ∈ {ℝ}^{N x {d}_{v}} . \qquad ( 1 )$$

The causal Mask ensures that all entries below the diagonal of the attention matrix do not contribute to the final output and thus that temporal order is respected. This allows conditioning on past observations when sampling from the model 312. If latent variables depend on the full sequence, they may be difficult to compute from past observations alone.

Regarding the quantizer module 308, to build an efficient latent representation of human motion sequences, the codebook of latent temporal representations may be used. More precisely, the quantizer module 308 maps a latent space representation \hat{Z} ϵ [symbol] ^{T}^{_{d}}^{xn}^{_{z}} to entries of the codebook z_{q} ϵZ^{T}^{_{d}} where Z is a set of C codes of dimension n_{z}. Generally speaking, this can be said to be equivalent to a sequence of T_{d} indices corresponding to the code entries on the codebook. A given sequence p can be approximately reconstructed by \hat{p}=D (Z_{q}) where z_{q} is determined by the encoder module 304 by encoding \hat{z}=E (x) ϵ [symbol] ^{T}^{_{d}}^{xn}^{_{z}} and mapping each temporal element of this tensor with q(·) to its closest codebook entry zₖ:

$${z}_{q} = q ( \hat{z} ) := ( arg {min}_{{z}_{k} ∈ X} ‖ {\hat{z}}_{t} - {z}_{k} ‖ ) ) ∈ {ℝ}^{{T}_{d} x {n}_{z}} \qquad ( 2 )$$

$$\hat{p} = D ( {Z}_{q} ) = D ( q ( E ) p ) ) . \qquad ( 3 )$$

Equation (3) above is non-differentiable. A training module 404 (FIG. 4) may back propagate the above based on a gradient estimator (e.g., a straight through gradient estimator) during which the backward pass approximates the quantization step as an identity function by copying the gradients from the decoder module 320 to the encoder module 304.

As illustrated by FIG. 5, the training module 404 trains the encoder module 304, the decoder module 320, and the codebook (used by the quantizer module 308) such that the decoder module 320 accurately reconstructs a sequence input to the encoder module 304. FIGS. 4 and 5 include example block diagrams of a training system. The training module 404 may train the encoder module 304, the decoder module 320, and the codebook (or the quantizer module 308 more generally) by optimizing (e.g., minimizing) the following loss:

[symbol]

_{VQ}(E,D,Z)=∥p−\hat{p}∥²+∥sg[E(p)−z_{q}∥²₂+β∥sg[z_{q}]−E(p)∥²₂ (4),

where sg is the stop-gradient operator. ∥sg[z_{q}]−E(p)∥²₂ may be referred to as a commitment loss and aids the training. The training module 404 trains the encoder module 304, the decoder module 320, and the quantizer module 308 before training the model 312. The loss may be optimized (e.g., minimized) when the output sequence of the decoder module 320 most closely matches the input sequence to the encoder module 304.

To increase the flexibility of the discrete representations generated by the encoder module 304, the quantizer module 308 may use product quantization where each element

$${\hat{z}}_{t} ∈ {ℝ}^{\frac{{n}_{z}}{KxK}}$$

where each chunk is discretized separately using K different codebooks {Z₁, . . . , Z_{K}}. The size of the discrete space learned increases exponentially with K yielding C^{T}^{_{d}}^{·K} combinations. Instead of indexing one target per time step, product quantization produces K targets. A prediction head may be used to model the K factors sequentially instead of in parallel, which may be referred to as an auto-regressive head.

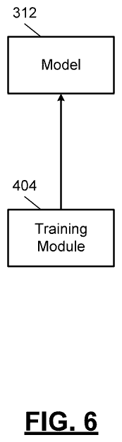

Training of the model 312 is performed by the training module 404 after the training of the encoder module 304, the quantizer module 308, and the decoder module 320 and is illustrated by FIGS. 6 and 7, which include functional block diagrams of the training system.

The latent representation z_{q}=q(E(p)) ϵ [symbol] ^{T}^{_{d}}^{xn}^{_{z}} produced by the encoder module 304 and the quantization operator q can be represented as the sequence of codebook indices of the encodings, i ϵ{0, . . . , |Z|−1}^{T}^{_{d}} by replacing each code by its index in the codebook z, iₜ=k by the quantizer module 312 such that (z_{q})ₜ=zₖ. Indices of I can be mapped back to corresponding codebook entries and decoded by the model 312 to a sequence \hat{p}=D(zᵢ₁, . . . ,z_{iT}_{_{d}}).

The training module 404 may learn a prior distribution over learned latent code sequences. The training module 404 inputs a motion sequence p of human action a to the encoder module 304. The encoder module 304 encodes the input (human motion sequence) into (iₜ)_{1 . . . T}_{_{d}}. The problem of latent sequence generation can then be considered as auto-regressive index prediction/determination. For this, temporal ordering is maintained which can be interpreted as time due to the use of causal attention in the encoder module 304.

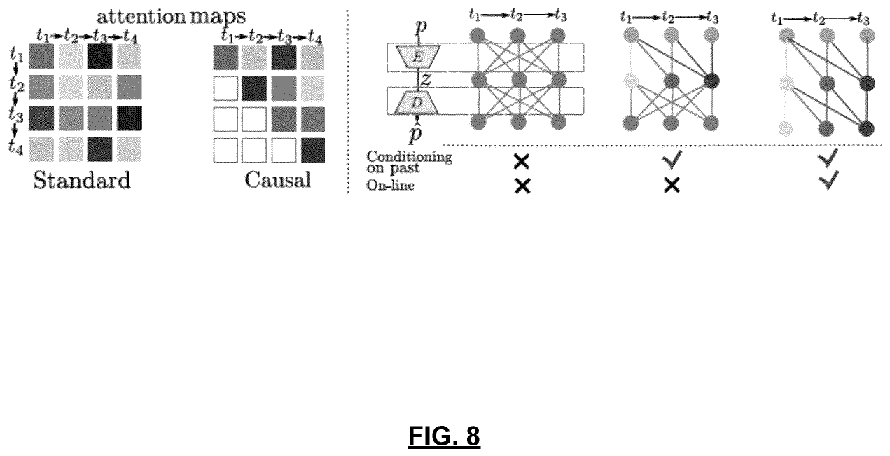

FIG. 8 includes an example illustration of causal attention of the encoder module 304. Attention maps of the encoder module 304 may be masked to provide causal attention. Attention maps of the decoder module 320 may also be masked. Masking the attention maps of the encoder module 304 enables the system to be conditioned on past observations. Masking the attention maps in the decoder module 320 allows the system to produce accurate predictions of future motion.

The model 312 may also include the transformer architecture. The training module 404 may train the model 312, which may be well suited for discrete sequential data, for example, using maximum likelihood estimation. Given i <j the action a and the duration (sequence length) T, the model 312 outputs a softmax distribution over the next indices,

p_{G}(iⱼ|i_{<j},α,T)

the likelihood of the latent sequence is

p_{G}(i)=Πⱼ_{^{p}}_{G}(iⱼ|i_{<j}, α, T).

The training module 404 may train the model 312, such as based on minimizing the loss

[symbol]

_{GPT}= [symbol] ᵢ[−Σⱼlogp_{G}(iⱼ|i_{<j}.α,T)]. (5)

The decoder module 320 decodes the output of the model 312 once trained. To summarize, a sequence of human motion is generated sequentially by sampling from p(sᵢ|s_{<i},α,T) to obtain a sequence of pose indices \tilde{z} given an action label and a duration (sequence length), and decoding the pose indices into a sequence of poses \tilde{p}=D(\tilde{z}).

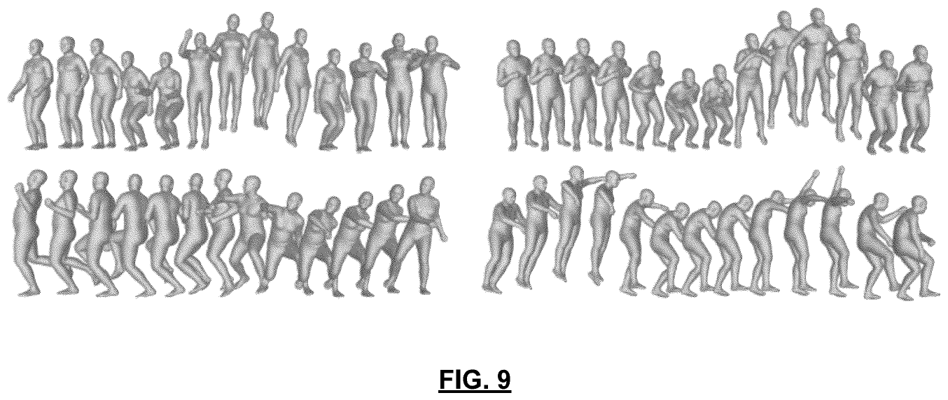

FIG. 9 includes example sequences of humans performing a selected action for selected durations generated without input observations. Time moves left to right. In the top row, the action is jumping. In the bottom row, the action is dancing. Blue texture corresponds to a first frame in the sequence and red texture is a last frame in the sequence.

The latent sequence space is set based on a bottleneck of the quantizer module 308 (quantization bottleneck). The latent sequence space is set based on capacity of the quantizer module 308, latent sequence length T_{d}, the number of the quantization factor K, the total number of centroids C. More capacity may yield lower reconstruction errors at the cost of less compressed representations. That may mean more indices to predict for the model 312, which may impact sampling.

Per vertex error (pve) may decrease (e.g., monotonously) with both K and C. With K=1, a high sample classification accuracy may be achieved, but provide decreased reconstruction. This may suggest insufficient capacity to capture full diversity of the data. More capacity (e.g., K=8) may yield lower performance. Best tradeoffs may be achieved with (K, C) ϵ{(2,256), (2,512), (4,128), (4,256)}.

The model 312 once trained can handle decreased temporal resolution. K=8 may provide functionality despite coarser resolution and compensate for a loss of information. Performance metrics may improve monotonically with K and C (e.g., because overfitting is not factored out by the performance metrics and the training dataset may be small enough to over-fit). An absolute compression cost of the model in bits may increases (z_{q} may include more information), while the cost per dimension decrease. Each sequence is easier to predict individually.

The parameters of the encoder module 304, the decoder module 320, and the quantizer module 308 may be fixed during the training of the model 312. Encoding the action label at each timestep (e.g., by the model 312), rather than providing the action label as an additional input to the transformer of the model 312 may improve performance. Conditioning on sequence length may also be beneficial. Concatenating the embedded information followed by linear projection, which may be similar to a learned weighted sum, may provide better performance than a summation. Using concatenation instead of summation may also enable faster training by the training module 404.

The output layer of the model 312 may be, for example, a multilayer perceptron (MLP) head (layer), a single fully connected layer, or an auto-regressive layer. An MLP head may perform better than a single fully connected layer, and an auto-regressive layer may perform better than an MLP head. This may be because with product quantization, codebook indices are extracted simultaneously from a single input vector but are not independent. Using an MLP head and/or an auto-regressive layer may better capture correlations between the codebook indices.

The causal attention of the encoder module 304 serves as a restriction flexibility and limits the inputs used by features in the encoder module 304. Causal attention allows the model 312 to be conditioned on past observations. Including causal attention in the decoder module 320 also improves performance and allows the model 312 to make observations and predictions in parallel.

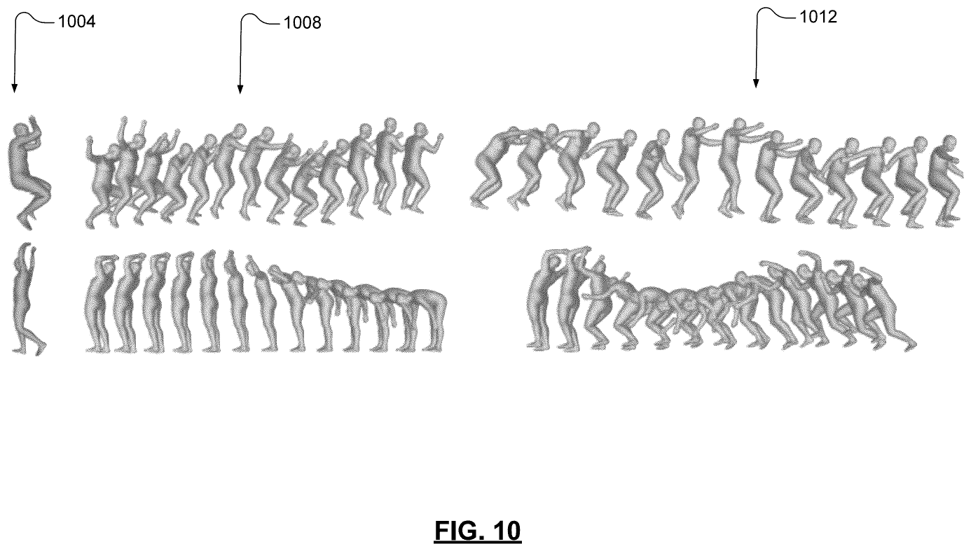

Sequences of human renderings generated by the rendering module 116 trained and as described herein generate human motion sequences that are realistic and diverse. FIG. 10 includes two rows of human motion sequences generated by the rendering module 116. 1004 are two different initial poses input to the encoder module 304. 1008 includes two rows of human motion sequences generated for two different actions based on the initial poses 1004 of the rows, respectively. 1012 also includes two rows of human motion sequences generated for two different actions based on the initial poses 1004 of the rows, respectively. The top row illustrates the action of jumping, and the bottom row illustrates the action of stretching. As illustrated, the rendering module 116 can generate different (diverse) human motion sequences for the same action despite receiving the same initial pose.

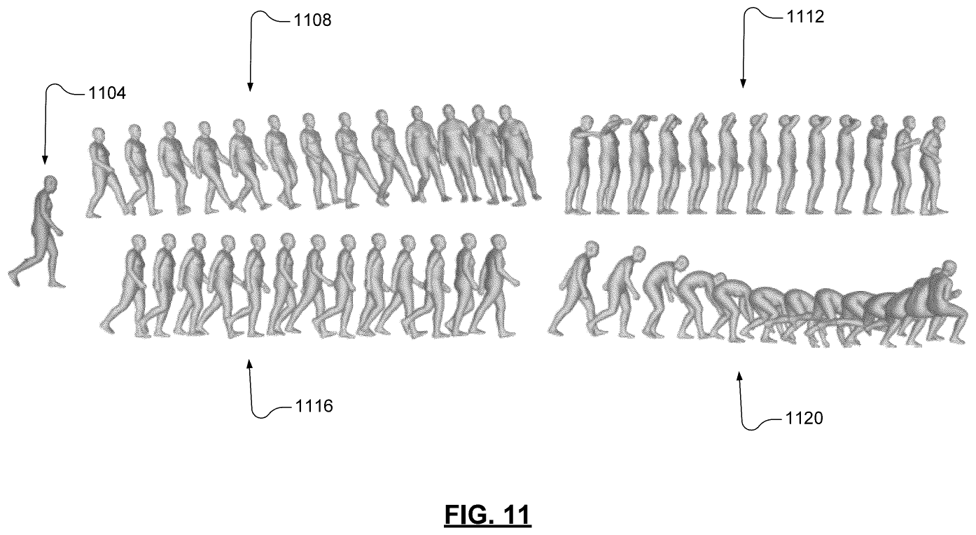

FIG. 11 includes one pose 1104 input to the encoder module 304. FIG. 11 also includes human motion sequences 1108, 1112, 1116, and 1120 generated by the rendering module 116 for the actions of turning, touching face, walking, and sitting, respectively. This illustrates that the input pose information is taken into account and affects the human motion sequence generated.

To summarize, the rendering module 116 includes an auto-regressive transformer architecture based approach that quantizes human motion into latent sequences. Given an action to be performed and a duration (and optionally an input observation), the rendering module 116 generates and outputs realistic and diverse 3D human motion sequences of the duration.

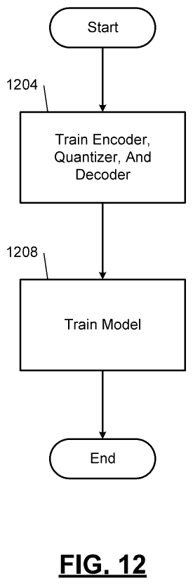

FIG. 12 is a flowchart depicting an example method of training the rendering module 116. Training begins with 1204 where the training module 404 trains the encoder module 304, the quantizer module 308, and the decoder module 320 based on minimizing the loss of equation (4) above. This involves the training module 404 inputting stored sequences of human motion into the encoder module 304 and training the encoder module 304, the quantizer module 308, and the decoder module 320 such that the decoder module 320 outputs human motion sequences that match the stored sequences of human motion input to the encoder module 304, respectively, as closely as possible. For example, the training module 404 inputs a stored sequence of human motion to the encoder module 304. The training module 404 compares a sequence of human motion generated by the decoder module 320 based on the stored sequence with the stored sequence. The training module 404 may do this for a predetermined number of stored sequences of human motion and/or a predetermined number of groups of a predetermined number of stored sequences of human motion. The training module 404 trains the encoder module 304, the quantizer module 308, and the decoder module 320 based on the comparisons. The training may involve selectively adjusting one or more parameters of at least one of the encoder module 304, the quantizer module 308, and the decoder module 320.

At 1208, the training module 404 trains the model 312, such as based on minimizing the loss of equation (5) above. This may involve the training module 404 inputting training data to the model 312 and comparing the indices generated by the model 312 for the human motion sequence with predetermined stored indices. The training module 404 may do this for a predetermined number of stored sets of training data (e.g., indices) and/or a predetermined number of groups of a predetermined number of sets of training data. The training module 404 trains the model 312 based on the comparisons. The training may involve selectively adjusting one or more parameters of the model 312. Once trained (the model 312, the encoder module 304, the quantizer module 308, and the decoder module 320), the rendering module 116 can generate accurate and diverse human sequences based on actions and durations with or without input human sequence motion observations.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment (of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A motion generation system, comprising:
a model configured to generate latent indices for a sequence of images including an entity performing an action based on an action label and a duration of the sequence; and
a decoder module configured to:
decode the latent indices and to generate the sequence of images including the entity performing the action based on the latent indices; and
output the sequence of images including the entity performing the action to a display control module configured to display the sequence of images including the entity performing the action sequentially on a display.

2. The motion generation system of claim 1 further comprising:
an encoder module configured to encode an input sequence of images including an entity into latent representations; and
a quantizer module configured to quantize the latent representations,
wherein the model is configured to generate the latent indices further based on the quantized latent representations.

3. The motion generation system of claim 2 wherein the encoder module includes an auto-regressive encoder.

4. The motion generation system of claim 2 wherein the encoder module includes the Transformer architecture.

5. The motion generation system of claim 2 wherein the encoder module includes a deep neural network.

6. The motion generation system of claim 2 wherein the encoder module is configured to encode the input sequence of images including the entity into the latent representations using causal attention.

7. The motion generation system of claim 2 wherein the encoder module is configured to encode the input sequence of images into the latent representations using masked attention maps.

8. The motion generation system of claim 2 wherein the quantizer module is configured to quantize the latent representations using a codebook.

9. The motion generation system of claim 1 wherein the action label and the duration is set based on user input.

10. The motion generation system of claim 1 wherein the decoder module includes an auto-regressive encoder.

11. The motion generation system of claim 1 wherein the decoder module includes a deep neural network.

12. The motion generation system of claim 11 wherein the deep neural network includes the Transformer architecture.

13. The motion generation system of claim 1 wherein the model includes a parametric differential body model.

14. The motion generation system of claim 1 wherein the entity is one of a human, an animal, and a mobile device.

15. A training system comprising:
the motion generation system of claim 2; and
a training module configured to:
input a training sequence of images including the entity into the encoder module;
receive an output sequence generated by the decoder module based on the training sequence; and
selectively train at least one of the encoder module, the quantizer module, and the decoder module based on matching the output sequence with the training sequence.

16. The training system of claim 15 wherein the training module is configured to train the model after the training of the encoder module, the quantizer module, and the decoder module.

17. The training system of claim 16 wherein the training module is configured to train the model based on adjusting an output of the model toward an expected output of the model stored in memory given an input.

18. A motion generation method, comprising:
by a model, generating latent indices for a sequence of images including an entity performing an action based on an action label and a duration of the sequence;
decoding the latent indices and to generate the sequence of images including the entity performing the action based on the latent indices; and
outputting the sequence of images including the entity performing the action to a display control module configured to display the sequence of images including the entity performing the action sequentially on a display.

19. The motion generation method of claim 18 further comprising:
encoding an input sequence of images including an entity into latent representations using an encoder module;
quantizing the latent representations,
wherein generating the latent indices comprises generating the latent indices further based on the quantized latent representations.

20. The motion generation method of claim 19 wherein the encoder module includes an auto-regressive encoder.

21. The motion generation method of claim 19 wherein the encoder module includes the Transformer architecture.

22. The motion generation method of claim 19 wherein the encoder module includes a deep neural network.

23. The motion generation method of claim 19 wherein the encoding includes encoding the input sequence of images including the entity into the latent representations using causal attention.

24. The motion generation method of claim 19 wherein the encoding includes encoding the input sequence of images into the latent representations using masked attention maps.

25. The motion generation method of claim 19 wherein the quantizing includes quantizing the latent representations using a codebook.

26. The motion generation method of claim 18 further comprising setting the action label and the duration based on user input.

27. The motion generation method of claim 18 wherein the decoding includes decoding using an auto-regressive encoder.

28. The motion generation method of claim 18 wherein the decoder module includes a deep neural network.

29. The motion generation method of claim 28 wherein the deep neural network includes the Transformer architecture.

30. The motion generation method of claim 18 wherein the model includes a parametric differential body model.

31. The motion generation method of claim 18 wherein the entity is one of a human, an animal, and a mobile device.

32. The motion generation method of claim 19 further comprising:
input a training sequence of images including the entity to the encoder module,
wherein the decoding is by a decoder module and the quantizing is by a quantizer module;
receiving an output sequence generated by the decoder module based on the training sequence; and
selectively training at least one of the encoder module, the quantizer module, and the decoder module based on matching the output sequence with the training sequence.

33. The training method of claim 32 further comprising training the model after the training of the encoder module, the quantizer module, and the decoder module.

34. The training method of claim 33 wherein the training the model includes training the model based on adjusting an output of the model toward an expected output of the model stored in memory given an input.
